(19) United States
(12) Patent Application Publication
(10) Pub. No.: US 2025/0378333 A1
(43) Pub. Date: Dec. 11, 2025

(54) METHOD AND COMPUTING SYSTEM FOR MODIFYING ARCHITECTURE OF DEEP-LEARNING MODEL

(71) Applicant: SAMSUNG ELECTRONICS CO., LTD., Suwon-si (KR)

(72) Inventors: Han Young YIM, Suwon-si (KR); Kyoung-Young KIM, Suwon-si (KR); Ye Sung KANG, Suwon-si (KR); Ki-Hyoun KWON, Suwon-si (KR); Kwon Sik KIM, Suwon-si (KR); Jae Gon KIM, Suwon-si (KR); Chang Gwun LEE, Suwon-si (KR); Woo-Hyun JOO, Suwon-si (KR); Sang Hyuck HA, Suwon-si (KR)

(21) Appl. No.: 19/227,117

(22) Filed: Jun. 3, 2025

(30) Foreign Application Priority Data
Jun. 11, 2024 (KR) 10-2024-0075740
Oct. 23, 2024 (KR) 10-2024-0145476

(51) Int. Cl. G06N 3/082; G06N 3/04; G06N 3/063

(52) U.S. Cl. CPC G06N 3/082; G06N 3/04; G06N 3/063

(57) ABSTRACT

The present disclosure relates to automated methods for modifying an architecture of a deep-learning model for improving inference performance based on the deep-learning model performed in a system-on-chip (SoC). An example method for modifying an architecture of a deep-learning model, executed by a computing system, comprises determining a target module among a plurality of layers included in an original deep-learning model, the target module including a plurality of layers having dependency, configuring a plurality of branches using the target module, the plurality of branches being independent of one another, and replacing the target module with the plurality of branches, thereby modifying the architecture of the original deep-learning model.

### CROSS-REFERENCE TO RELATED APPLICATIONS

This application claims priority from Korean Patent Application No. 10-2024-0075740 filed on Jun. 11, 2024 and Korean Patent Application No. 10-2024-0145476 filed on Oct. 23, 2024 in the Korean Intellectual Property Office, and all the benefits accruing therefrom under 35 U.S.C. 119, the contents of which in its entirety are herein incorporated by reference.

### BACKGROUND

Inference models of an artificial neural network architecture are widely used. The artificial neural network includes an input layer, a hidden layer structure having one or more layers, and an output layer. Each layer in the network is disposed sequentially from an input layer toward an output layer. Furthermore, the artificial neural network has a plurality of weights that connect nodes of immediately adjacent layers, and each weight is updated in a training stage.

When an artificial intelligence model of the artificial neural network architecture is deployed in a low-level computing system such as a user terminal, an edge device itself may perform an inference based on an artificial intelligence technology for a given situation. The artificial intelligence model deployed in the user terminal is also called on-device artificial intelligence (on-device AI). In order to improve the inference performance of the on-device AI, the user terminal may be equipped with a computing device specialized for the computation required in the inference process based on the artificial neural network, such as a neural processing unit (NPU) or a graphics processing unit (GPU).

Recently, data size of NNC file or the like that expresses the deep-learning models has increased rapidly with an emergence of a generative artificial intelligence (generative AI). However, an on-chip memory size and a bandwidth of an off-chip memory of system on chip (SoC), such as NPU, for accelerating this are limited. Therefore, an optimization technique for improving the performance of the deep-learning model and increasing an energy efficiency under limited memory size and restricted bandwidth conditions is desired.

### SUMMARY

The present disclosure relates to an automated method for modifying an architecture of a deep-learning model for improving inference performance based on the deep-learning model performed in a system-on-chip (SoC) including a computing means.

The present disclosure also relates to a method for performing an automated architecture modification of a deep-learning model autonomously inside a SoC and then performing an inference, using the deep-learning model of the modified architecture.

The present disclosure also relates to a SoC that autonomously performs an automated architecture modification of the deep-learning model on an input deep-learning model and then performs the inference using the deep-learning model of the modified architecture.

However, the present disclosure are not restricted to the one set forth herein. The above and other aspects of the present disclosure will become more apparent to one of ordinary skill in the art to which the present disclosure pertains by referencing the detailed description of the present disclosure given below.

In some implementations, a method for modifying an architecture of a deep-learning model, executed by a computing system, is provided. The method comprises, determining a target module among a plurality of layers included in an original deep-learning model, the target module including a plurality of layers having dependency, configuring a plurality of branches using the target module, the plurality of branches being independent of one another and replacing the target module with the plurality of branches, thereby modifying the architecture of the original deep-learning model. The modification of the architecture of the original deep-learning model may include, configuring so that each of a plurality of slice inputs obtained by slicing an input to the target module on the basis of a first axis is input to each of the plurality of branches and the dependency refers to an output of a previous layer being used as an input of a subsequent layer.

In some implementations, a method performed by a system-on-chip (SoC) including a computing means, is provided. The method comprises, receiving an input of data representing an original deep-learning model, determining a target module among a plurality of layers included in the original deep-learning model, the target module including a plurality of layers having dependency, configuring a plurality of branches using the target module, the plurality of branches being independent of one another, replacing the target module with the plurality of branches, thereby modifying the architecture of the original deep-learning model and sequentially processing each of the plurality of branches included in the deep-learning model of the modified architecture. The modification of the architecture of the original deep-learning model may include, configuring so that each of a plurality of slice inputs obtained by slicing an input to the target module on the basis of a first axis is input to each of the plurality of branches, and the dependency refers to an output of a previous layer being used as an input of a subsequent layer.

In some implementations, a neural processing unit (NPU) comprising a control unit which includes a control logic and a cache, a plurality of ALU units which include an arithmetic logic unit (ALU) and a cache is provided. The control logic may include a model optimization logic. The model optimization logic may include determining a target module among a plurality of layers included in the original deep-learning model, the target module including a plurality of layers having dependency, configuring a plurality of branches using the target module, the plurality of branches being independent of one another, replacing the target module with the plurality of branches, thereby modifying the architecture of the original deep-learning model, and controlling each of the plurality of branches included in the deep-learning model of the modified architecture to be processed sequentially. The modification of the architecture of the original deep-learning model may include configuring so that each of a plurality of slice inputs obtained by slicing an input to the target module on the basis of a first axis is input to each of the plurality of branches. The dependency may refer to an output of a previous layer being used as an input of a subsequent layer.

### BRIEF DESCRIPTION OF THE DRAWINGS

The above and other aspects and features of the present disclosure will become more apparent by describing in detail implementations thereof referring to the attached drawings.

FIGS. 1, 2, and 3 are configuration diagrams of an example of an inference system based on a deep-learning model.

FIG. 4 is a configuration diagram of an example of an SoC.

FIG. 5 is a flowchart of an example of a method for modifying an architecture of the deep-learning model.

FIG. 6 is a detailed flowchart for explaining in more detail an example of a partial operation of the method for modifying the architecture of the deep-learning model described referring to FIG. 5.

FIG. 7 is a diagram of an example of an original deep-learning model for explaining a process of modifying the architecture of the deep-learning model.

FIG. 8 is a diagram showing an example of a result of architecture modification of the original deep-learning model shown in FIG. 7.

FIGS. 9, 10, 11, and 12 are diagrams for explaining an example of a process by which the result of architecture modification of the original deep-learning model shown in FIG. 8 is derived.

FIG. 13 is a diagram showing a part of an example of an original deep-learning model for explaining the process of modifying the architecture of the deep-learning model.

FIG. 14 is a diagram showing an example of a task execution flow when an inference computation based on a deep-learning model in which an architecture is modified is executed by a SoC including a computing means, together with the execution of the inference computation based on the original deep-learning model.

FIG. 15 is a hardware configuration diagram of an example of a computing system.

### DETAILED DESCRIPTION

Hereinafter, example implementations of the disclosure will be described with reference to the attached drawings. The advantages and features of the disclosure and methods of accomplishing the same would be understood more readily by reference to the following detailed description of example implementations and the accompanying drawings. The disclosure may, however, be implemented in many different forms and should not be construed as being limited to the example implementations set forth herein. Rather, these implementations are provided so that this disclosure will be thorough and complete and will fully convey the concept of the disclosure to those skilled in the art, and the disclosure will be defined by the appended claims and their equivalents. In describing the disclosure, if it is determined that a detailed description of a related known configuration or function may obscure the gist of the disclosure, the detailed description will be omitted.

The singular expressions used in the following implementations include plural concepts, unless the context clearly specifies singularity. Additionally, plural expressions include singular concepts, unless the context clearly specifies plurality. In addition, terms such as first, second, A, B, (a), (b) used in the following implementations are only used to distinguish one element from another element, and the terms do not limit the nature, sequence, or order of the relevant elements.

The elements described with reference to terms such as unit, module, block, etc. used in the disclosure and the functional blocks shown in the drawings may be implemented in the form of software, hardware, or a combination thereof. For example, the software may be machine code, firmware, embedded code, and application software. For example, the hardware may include an electrical circuit, an electronic circuit, a processor, a computer, an integrated circuit, integrated circuit cores, passive components, or a combination thereof.

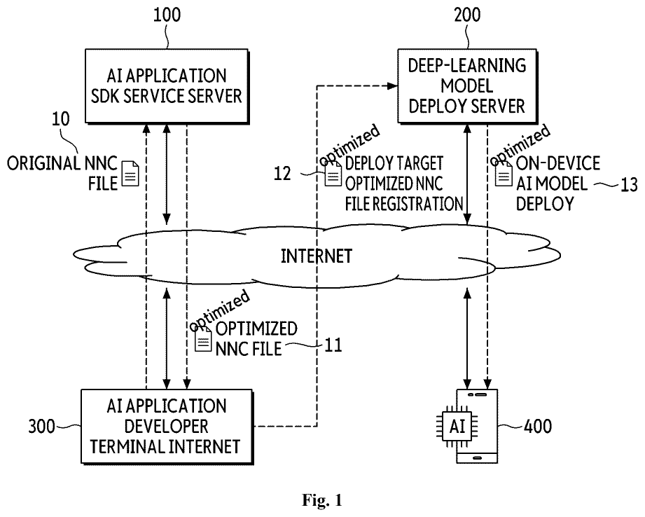

Hereinafter, a configuration and an operation of an inference system based on a deep-learning model according to an implementation of the present disclosure will be described referring to FIGS. 1 to 3.

As shown in FIG. 1, an inference system based on a deep-learning model may include an AI application SDK service server 100. In some implementations, the inference system based on the deep-learning model of the present implementation may further include an AI application developer terminal 300, a deep-learning model deploy server 200, and a device 400. FIGS. 1, 2, and 3 show different system configurations of an example of the inference system based on the deep-learning model. Hereinafter, a system configuration will be described referring to FIG. 1.

A user of an AI application developer terminal 300 on which AI application development software is installed may develop an AI application using an AI application development SDK, a framework or the like, and compile the results developed using the AI application development environment by the use of an AI compiler, thereby generating deep-learning model expression data such as an NNC file. In this disclosure, a deep-learning model before the architecture modification of the deep-learning model will be referred to as an “original deep-learning model”. The AI application developer terminal 300 may request the AI application service server 100 to perform an architecture modification of the original deep-learning model, by transmitting the original NNC file 10 representing the original deep-learning model to the AI application SDK service server 100.

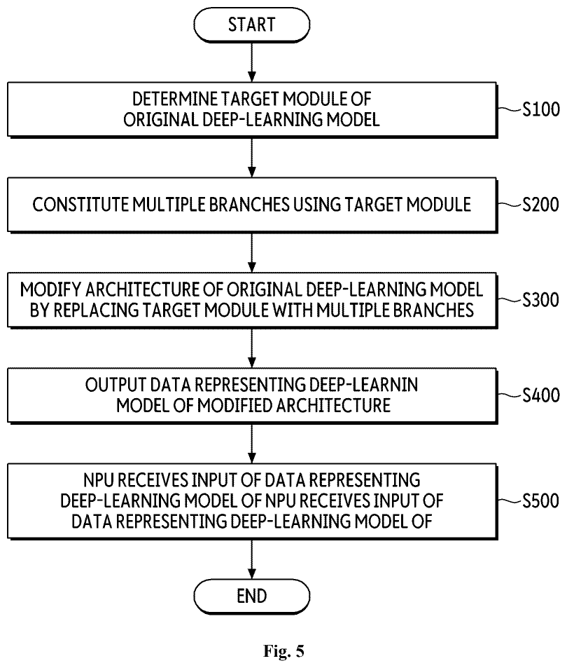

The AI application SDK service server 100 may be a server system that provides a service of downloading an SDK for developing the AI application and an architecture modification of the deep-learning model based on the SDK. The AI application SDK service server 100 may modify the architecture of the original deep-learning model, by receiving the original NNC file 10 received from the AI application developer terminal 300 and by performing deep-learning model architecture modification logic described in this disclosure on the original deep-learning model represented by the original NNC file 10. The deep-learning model architecture modification logic will be described in detail referring to the implementations described through FIGS. 5 to 14.

The architecture modification of the original deep-learning model described above may be for optimization when a computation related to inference based on the original deep-learning model is performed in the SoC including the computing means such as an NPU. Therefore, the original deep-learning model in which an architecture is modified in this disclosure or drawings may also be referred to as an “optimized deep-learning model.”

The AI application SDK service server 100 may generate an optimized NNC file 11 that represents the optimized deep-learning model, and transmit it to the AI application developer terminal 300. In addition, the AI application developer terminal 300 may transmit a deploy target registration request 12 involving the optimized NNC file 11 instead of the original NNC file 10 to the deep-learning model deploy server 200.

The deep-learning model deploy server 200 may deploy (13) the optimized NNC file 11 received from the AI application developer terminal 300 to the device 400.

The device 400 may be a computing device equipped with computing means for performing the computation for performing the inference using the on-device AI. For example, the computing means may be provided in the computing device in the form of a SoC such as a neural processing unit (NPU), a graphic processing unit (GPU), and a tensor processing unit (TPU). The device 400 will execute inference based on the deep-learning model by inputting the optimized NNC file 11 to the SoC, and output the result thereof. The device 400 may be a device such as a smartphone, a tablet, a desktop PC, a notebook, an edge node according to edge computing technology, and an IoT gateway.

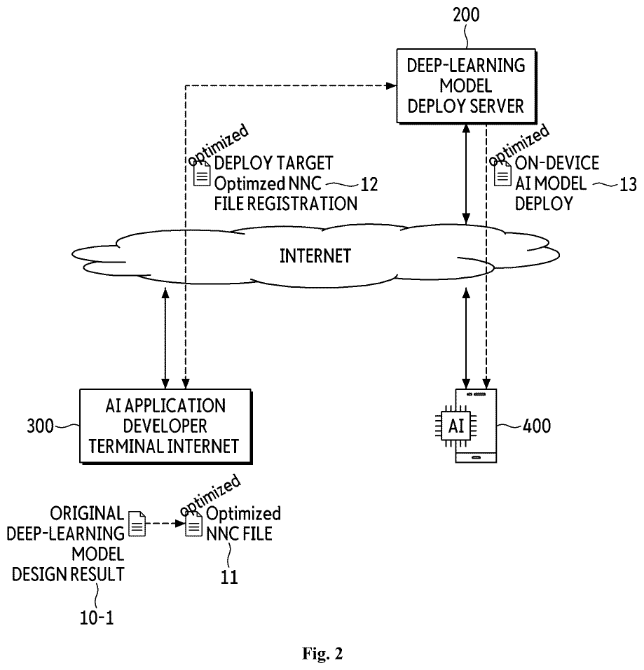

Unlike those described referring to FIG. 1, an inference system based on the deep-learning model according to another implementation of the present disclosure may include an AI application developer terminal 300 and a deep-learning model deploy server 200. Hereinafter, a description will be given referring to FIG. 2.

The inference system based on deep-learning model according to the present implementation does not include the AI application SDK service server 100, and the AI application developer terminal 300 may execute the deep-learning model architecture modification logic executed by the AI application SDK service server 100 in the description referring to FIG. 1.

As described above, the AI application developer terminal 300 is installed with AI application development software, and the AI application development software may include an AI application SDK.

In some implementations, the AI application SDK may include an API for executing the deep-learning model architecture modification logic.

In some implementations, the AI application SDK may include a model conversion and optimization library, and the model conversion and optimization library may include one or more API data architectures for executing the deep-learning model architecture modification logic.

In some implementations, the AI application SDK may include a quantization library that converts the weight and activation function output of the neural network to be represented in fewer number of bits to improve the execution performance and efficiency of the AI model, and the quantization library may include one or more APIs and data architectures for executing the deep-learning model architecture modification logic.

In some implementations, the AI application SDK may include a compile library, and the compile library may include one or more APIs and data architectures for executing the deep-learning model architecture modification logic.

A result 10-1 obtained by completing the design using the AI application development software by the user of the AI application developer terminal 300 may be output in the form of an optimized NNC 11 by the AI application developer terminal 300. The AI application developer terminal 300 may transmit a deploy target registration request 12 involving the optimized NNC file 11 to the deep-learning model deploy server 200. The deep-learning model deploy server 200 may deploy (13) the optimized NNC file 11 received from the AI application developer terminal 300 to the device 400.

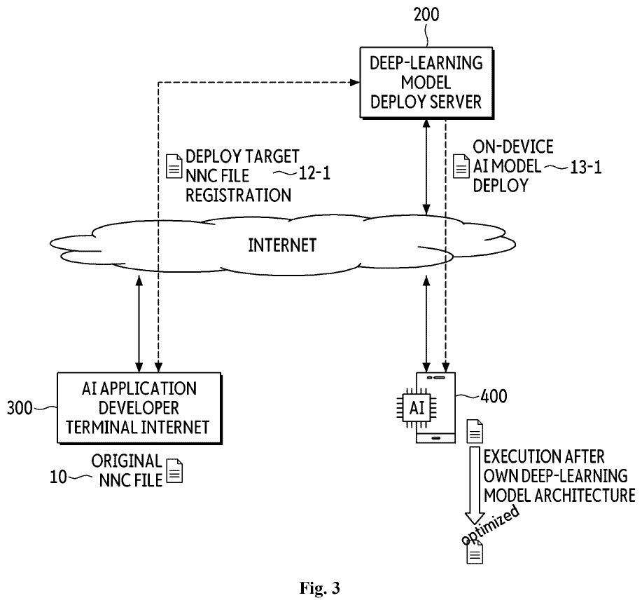

Unlike that described referring to FIG. 2, an inference system based on the deep-learning model according to still another implementation of the present disclosure may execute the deep-learning model architecture modification logic on the device 400 itself. The following description will be given referring to FIG. 3.

The AI application developer terminal 300 transmits a deploy target registration request 12-1 involving the original NNC file 10 to the deep-learning model deploy server 200. The deep-learning model deploy server 200 may deploy (13-1) the original NNC file 10 to the device 400. That is, unlike that described referring to FIGS. 1 and 2, the device 400 may receive the original deep-learning model instead of the deep-learning model with a modified architecture from the deep-learning model deploy server 200, execute the deep-learning model architecture modification logic on the device 400 itself before performing an inference computation using the received deep-learning model, and as a result, perform an inference computation using the deep-learning model of the modified architecture.

The device 400 may execute the deep-learning model architecture modification logic using the software installed in the device 400. For example, a deep-learning model optimization middleware installed in the device 400 may execute the deep-learning model architecture modification logic, or a driver of the SoC equipped with the computing means may execute the deep-learning model architecture modification logic. Although the SoC may be, for example, a GPU, an NPU, a TPU, or the like, as described above, for the sake of convenience of understanding, the description will be given assuming that the SoC is an NPU.

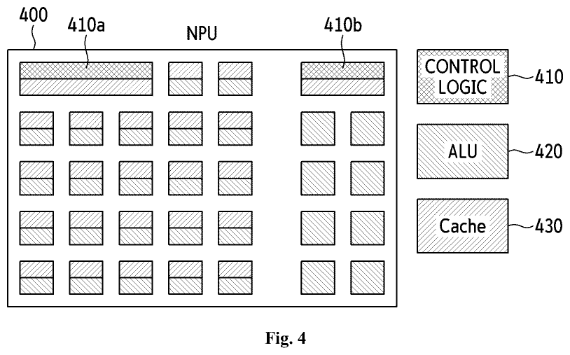

As described above, the NPU provided in the device 400 may execute the deep-learning model architecture modification logic by itself, and the configuration and operation of the SoC such as the NPU provided in the device 400 will be described referring to FIG. 4.

FIG. 4 is a configuration diagram of an example of a SoC. The SoC according to the present implementation may include one or more control units including a control logic 410 and a cache 430, and a plurality of ALU units including an arithmetic logic unit (ALU) 420 and a cache 430. The configuration diagram of the SoC shown in FIG. 4 may be, for example, a configuration diagram of the NPU.

The one or more control units may include a general-purpose control unit 410a and a model optimization control unit 410b that control the operation of the NPU. The model optimization control unit 410b may include a model optimization logic. It may be understood that the model optimization logic is logic that executes the deep-learning model architecture modification logic.

The deep-learning model architecture modification logic described so far will be described in detail below referring to FIGS. 5 to 12, and may be organized as including following operations 1 to 3.

Operation 1: A target module (that includes a plurality of layers having dependency) is determined among a plurality of layers included in the original deep-learning model. The dependency means that an output of a previous layer is used as an input of a subsequent layer.

Operation 2: A plurality of branches (the plurality of branches are independent of each other) are configured using the target module. Independence between the plurality of branches means that there is no input/output relationship of data between different branches from each other. That is, the independence between the branches may refer to an absence of the above-mentioned dependency between the branches.

Operation 3: The architecture of the original deep-learning model is modified by replacing the target module with the plurality of branches. At this time, each of a plurality of slice inputs, which are obtained by slicing the input to the target module on the basis of a pre-specified one axis or a plurality of pre-specified axes, is configured to be input to each of the plurality of branches.

Meanwhile, the model optimization logic may additionally include an operation of controlling each of the plurality of branches included in the deep-learning model of the modified architecture to be sequentially processed through the plurality of ALU units after performing the operations 1 to 3. The control of each of the plurality of branches to be sequentially processed may mean that after an inference computation related to layers included in one branch is finished, an inference computation related to the layers included in the next branch is performed.

Hereinafter, a method for modifying the architecture of the deep-learning model according to another implementation of the present disclosure will be described. The method for modifying the architecture of the deep-learning model according to the present implementation may be executed by a computing device or a computing system consisting of a plurality of computing devices. For example, the method for modifying the architecture of the deep-learning model according to the present implementation may be performed by a server system. In addition, the method for modifying the architecture of the deep-learning model according to the present implementation may be performed by a computing terminal device used by the AI application developer.

In addition, the method for modifying the architecture of the deep-learning model according to the present implementation may be performed by collaboration between a first computing device and a second computing device. The technical ideas that may be understood through the implementations described referring to FIGS. 1 to 4 may be obviously reflected in the method for modifying the architecture of the deep-learning model according to the present implementation, even if it is not separately specified.

Hereinafter, an overall flow of an example of the method for modifying the architecture of the deep-learning model will be described referring to FIG. 5.

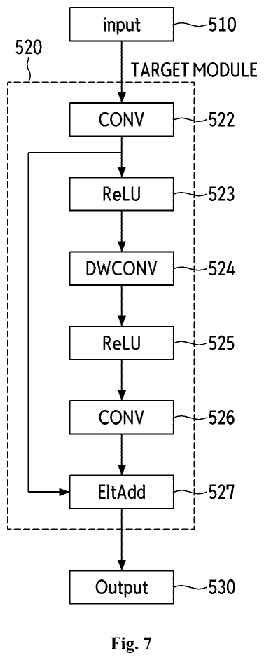

First, in S100, a target module is determined among a plurality of layers included in the original deep-learning model. The target module may mean a plurality of layers to be replaced by a plurality of branches. The plurality of layers included in the target module may have a dependency between them. The dependency may refer to the output of a previous layer being used as the input of a subsequent layer. For example, in the original deep-learning model shown in FIG. 7, remaining layers 522 to 527, except for an input layer 510 and an output layer 530, use the output of the previous layer as the input of the subsequent layer. Since there is a dependency between the layers 522 to 527, all the remaining layers 522 to 527 may be specified as the target module 520.

Of course, it is not necessary to specify all layers that have a dependency as the target module. As policy items related to the method for modifying the architecture of the deep-learning model according to the present implementation, the maximum number of layers that may be included in the target module, an input side gap size indicating the number of layers that may not be included in the target module as the input layer and its adjacent layers, and an output side gap size indicating the number of layers that may not be included in the target module as the output layer and its adjacent layers, and the like may be set. The target module may be specified within a range that complies with the setting items of the policy items.

The description will be given again returning to FIG. 5. In step S200, the plurality of branches are configured using the above-specified target module. In step S300, the specified target module is replaced with the configured plurality of branches, and the architecture of the original deep-learning model may be modified so that each of the plurality of slice inputs obtained by slicing the input to the target module on the basis of a pre-specified axis is input to each of the plurality of branches. The pre-specified axis may be a part of the axis that constitutes the input data to the target module.

In some implementations, each slice input may be obtained by slicing the input to the target module on the basis of a pre-specified axis. Furthermore, in some implementations, each slice input may be obtained by slicing the input to the target module on the basis of the pre-specified plurality of axes.

Furthermore, in some implementations, the architecture of the original deep-learning model is modified so that each of the plurality of slice inputs obtained by slicing the input to the target module on the basis of a batch of the input data is input to each of the plurality of branches. For example, when a total of three branches are configured, a 3i+1^{th} (here, i is a natural number equal to or greater than 0) batch may be input to an i^{th} branch.

Furthermore, in some implementations, each slice input may be obtained by slicing the input to the target module on the basis of the batch of the input data and at least a part of one or more pre-specified axes.

In step S400, data representing the deep-learning model of the modified architecture may be output. As a result of the output, a file of a format that compresses and represents the deep-learning model architecture, such as ENN, may be generated.

In step S500, a SoC equipped with a computing means such as an NPU may perform inference computation, by receiving the input of data representing the deep-learning model of the modified architecture and sequentially executing each branch included in the deep-learning model of the modified architecture.

The computation of each layer of the branch and the connection relationship for each layer may be the same as the computation of each layer of the target module and the connection relationship for each layer. That is, in this case, the architecture of the original deep-learning model concatenates a plurality of branches that are copies of the target module in parallel, and the input to each branch may be modified to a form in which a slice input obtained by slicing the input to the target module on the basis of a specific axis is set.

On the other hand, the branch may be one that reflects at least a part of a first modification and a second modification of layer creation of parameter modification of at least some of the layers included in the target module on the basis of the layer of the target module.

The parameters of the layer may mean parameters related to the computation performed in that layer. For example, a CONV layer 522, which is the layer immediately after the input layer 510 of FIG. 7, is a layer that performs a convolution computation, and may include information on the size and direction of padding as its parameters.

Whether the branch is configured to be the same as the target module or reflects at least a part of the first modification and the second modification on the basis of the layer of the target module may be determined, using the input size and output size of each layer included in the target module.

In addition, the plurality of branches may have the same layer configuration as each other, but even though some branches have some layer configurations different from the remaining branches or have the same layer configuration, some branches may be configured to have parameters different from each other. That is, the plurality of branches may be configured as the plurality of types of branches having different layer configurations or parameters from each other.

In some implementations, if padding in at least one direction is added to at least some of the convolution layers (including DW (Depth-Wise) convolution layers) included in the target module, the plurality of branches will be configured as the plurality of types of branches with different layer configurations or parameters from each other. At this time, when a first branch that receives a first slice input that is the first slice input among the plurality of slice inputs, and a second branch that receives a second slice input that is the slice input immediately after the first slice input are configured, the parameters of the layer corresponding to the convolution layer of the first branch may be different from the parameters of the layer corresponding to the convolution layer of the second branch.

For example, when padding in at least one direction is added to the input data to the convolution layer, the parameters of the layer corresponding to the convolution layer of the first branch may be set to be different from the parameters of the layer corresponding to the convolution layer of the second branch. That is, as a convolution layer involving the padding for the input data is included in the target module, the parameters related to the padding application direction of the convolution layer included in each type of branch may be set to be different from each other for each branch type.

On the other hand, if all the convolution layers included in the target module perform convolution computations with no padding, all the plurality of branches may be configured to have the same layer and parameter configuration.

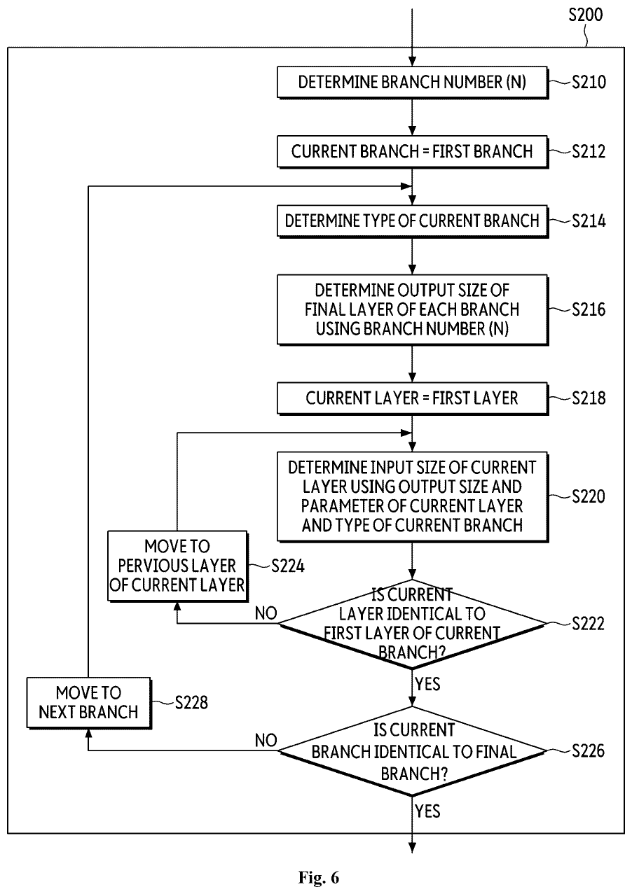

An operation (S200) of configuring the plurality of branches will be described in more detail below referring to FIGS. 6 to 13.

In step S210, the number N of branches included in the plurality of branches may be determined. The number of branches N may be determined as any one of a plurality of pre-specified numbers, using the size of the input or the size of the output to the target module. For example, the number N of branches may be determined, using the size of a pre-specified axis on the basis of slice in the input or the output to the target module.

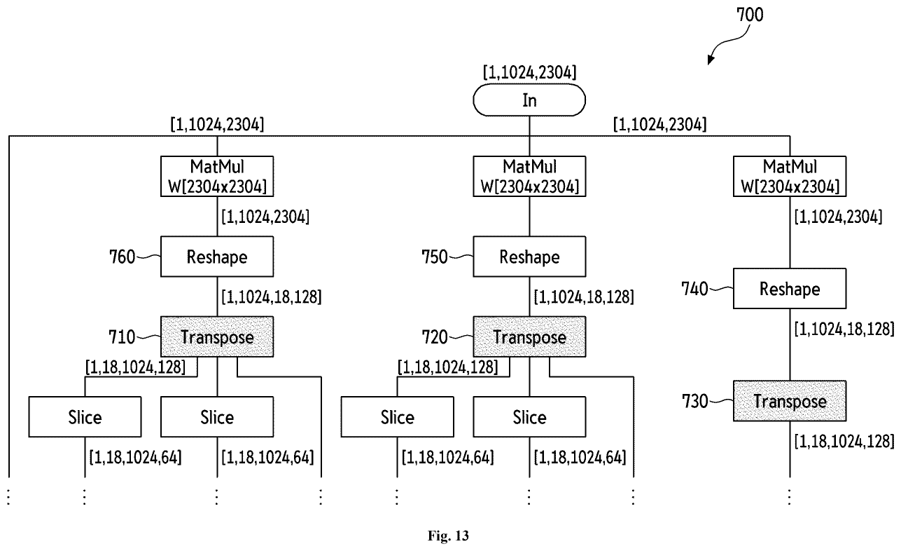

The plurality of numbers may be any one of the square of 2, such as 2, 4, 8, and 16, or may be determined, using the size of the input or the size of the output of the layer to be removed in order to remove the layer to be removed included in the target module, as in the implementation described below referring to FIG. 13.

Next, determination (S214 to S224) of the input size of each layer belonging to the branch is repeatedly performed for each branch. For this purpose, the current branch may be initialized to the first branch (S212).

The data size that is input to the input layer 510 of the original deep-learning model shown in FIG. 7 is assumed to be (1, 3, 96, and 96) (batch size, number of channels, HEIGHT, and WIDTH), and the data size that is output from the output layer 530 is also assumed to be (1, 3, 96, and 96) (batch size, number of channels, HEIGHT, and WIDTH). Also, the axis which becomes a reference of the slice is assumed to be HEIGHT. As described above, the number of branches N may be determined on the basis of 96, which is the input/output data size of the HEIGHT axis which becomes the reference of the slice.

For example, a normal range of the data size of the HEIGHT axis covered by one branch may be specified, and when the normal range is assumed to be 30 to 40, the number of branches N may be 3.

In some implementations, the data size of the final output of each branch may be the same. However, in some implementations, the data size of the final output of each branch may be different from each other. Hereinafter, for ease of understanding, the explanation will be made assuming a case where the data size of the final output of each branch is the same.

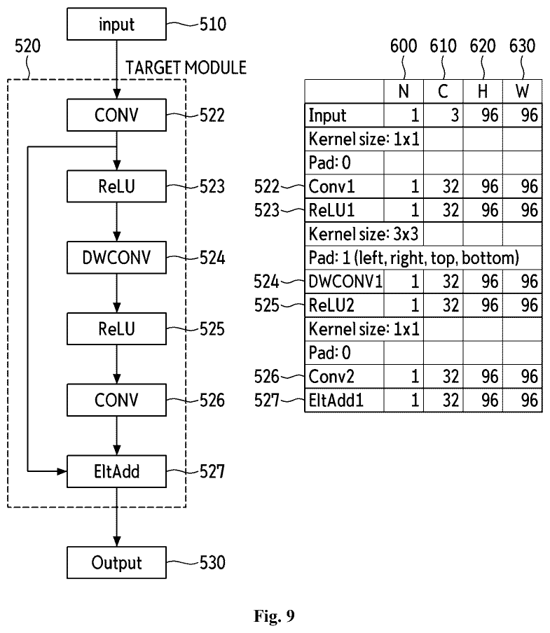

It has been described that when padding in at least one direction is added to at least some of the convolution layers included in the target module, the plurality of branches may be configured as the plurality of types of branches having different layer configurations or parameters from each other. Referring to FIG. 9, the example original deep-learning model presented in FIG. 7 includes a depth-wise convolution (DWCONV) layer 524 involving a size 1 padding computation on the input data. Therefore, the three branches generated using the target module 520 will be configured as the plurality of types of branches.

For reference, as shown in FIG. 9, each of the convolution layers 522 and 526 and the first DWCONV layer 524 included in the target module 520 may have one or more parameters. The parameters may include at least some of the values of the size of padding and direction of padding, and the kernel size.

As shown in FIG. 9, the first DWCONV layer 524 is a convolution computation that performs padding by 1 in four directions (LEFT, RIGHT, TOP, and BOTTOM).

Kernel size parameters and padding size parameters of the layers in each branch corresponding to the first to second convolution layers 524 and the first DWCONV layer 524 of the target module 520 may be maintained as they are, in the same manner as the size parameters and padding size parameters of the first to second convolution layers 522 and 526 and the first DWCONV layer 524 of the target module 520. However, the parameters for the padding direction of the first DWCONV layer 524 of each branch that performs padding on the input data may be modified on the basis of the parameters for the padding direction of the first DWCONV layer 524 of the target module 520. Furthermore, the parameters for the padding direction of the first DWCONV layer 524 of each branch may differ from each other for each branch type.

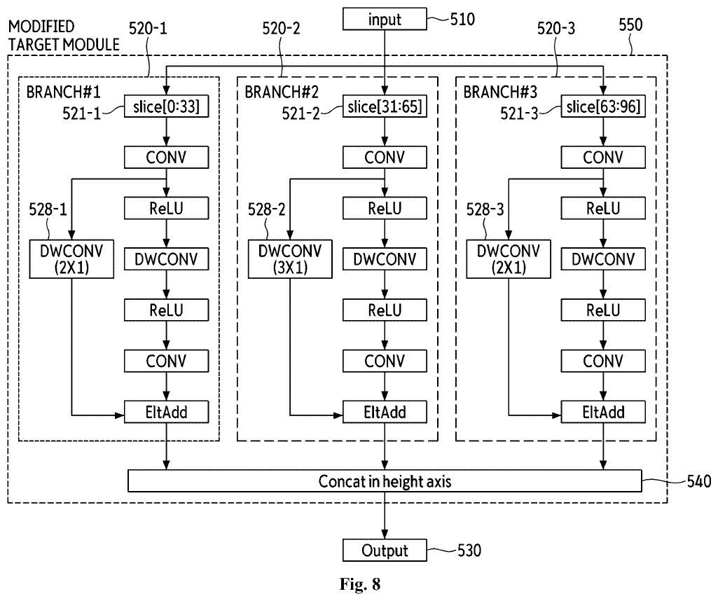

The deep-learning model architecture modification logic will be described in more detail below referring to FIGS. 8, 10 to 12.

As described above, three branches 520-1, 520-2, and 520-3 shown in FIG. 8 receive input of three slice inputs 521-1, 521-2, and 521-3 sliced on the basis of a HEIGHT axis. In addition, a first branch 520-1 is a branch type that receives the input of the first slice input 521-1 formed as a coordinate region including 0 on the basis of the HEIGHT axis, a third branch 520-3 is a branch type that receives the input of the last slice input 521-3 formed as a coordinate region including 96 that is the last coordinate on the basis of the HEIGHT axis, and a second branch 520-2 is a branch type that receives input of an intermediate slice input 521-2 formed as an intermediate coordinate region on the basis of the HEIGHT axis. If the number of branches N is 4 or more, one or more branches of the same type as the second branch 520-2 will be further configured.

At this time, as described above, the size of the final output of each of the branches 520-1, 520-2, and 520-3 may be determined as 32 by dividing 96 that is the input/output data size of the HEIGHT axis which becomes the reference of the slice by 3 which is the number of branches N, and the size of each slice input for each branch is not determined as 32.

The size of each of the slice inputs for each branch may be determined, by repeating determination of input size of each layer, using the output size, parameters and branch type of each layer while performing the layer circulation from the final layer to the first layer of each of the plurality of branches, until the input size of the first layer is determined.

Furthermore, padding may be performed only in the (LEFT, RIGHT, and TOP) directions on the convolution layer of the first branch 520-1 to which the first slice input 521-1 is input. Since the slice for the input is performed on the basis of the HEIGHT axis, even if padding is performed in the TOP direction of the first slice input 521-1, the same convolution computation result as the padding for the target module is obtained. However, if padding is performed in the BOTTOM direction of the first slice input 521-1, a convolution computation result different from the padding for the target module will be obtained. This is because the actual data, not padding data, is located in the BOTTOM direction of the first slice input 521-1 in the input to the target module.

As described above, depending on the relative position of each slice input on the axis that is the reference of the slice, the padding direction parameters of the convolutional layers included in each branch that receives the slice input change from one another.

As described above, all the convolution layers 522, 524, and 526 included in the target module 520 perform padding in four directions (LEFT, RIGHT, TOP, and BOTTOM). However, parameters related to padding will be set such that all the convolution computations 522, 524 and 526 of the first branch 520-1 that receives the first slice input 521-1 based on the HEIGHT axis perform padding only in the three directions (LEFT, RIGHT, and TOP) except the BOTTOM direction, parameters related to padding will be set such that all the convolution computations 522, 524 and 526 of the third branch 520-3 that receives the last slice input 521-3 based on the HEIGHT axis perform padding only in the three directions of (LEFT, RIGHT, and BOTTOM) except the TOP direction, and parameters related to padding will be set such that all the convolution computations 522, 524, and 526 of the second branch 520-2 which receives the intermediate slice input 521-2 based on the HEIGHT axis performs padding only in two directions (LEFT and RIGHT) except the TOP and BOTTOM directions.

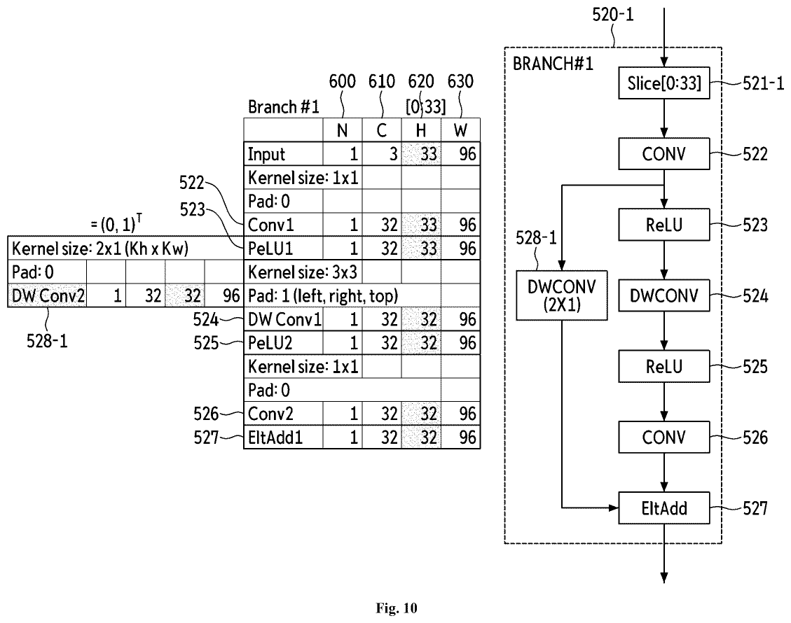

Due to a difference in padding direction for each branch type, a decrease in output data size in comparison to the input data size of the convolution computation changes for each branch type. This will be described below referring to FIGS. 10 to 12.

Referring to FIG. 10, in the first branch 520-1 that performs padding the padding of the convolution computation only in three directions (LEFT, RIGHT, and TOP), the data size of the HEIGHT axis decreases by the padding size each time the convolution computation is performed. If padding is not performed, the data size of the HEIGHT axis does not decrease when the convolution computation is performed. As a result, the data size of the HEIGHT axis is maintained as 33 as it is when the second convolution computation 526 with a padding size of 0 is performed. The data size of the HEIGHT axis decreases from 33 to 32 when the first DWCONV computation 524 with a padding size of 1 is performed. The data size of the HEIGHT axis is maintained as 33 as it is when the first convolution computation 522 with a padding size of 0 is performed. Since the first convolution computation 522 is the first layer of the first branch 520-1, the data size of the HEIGHT axis of the slice input 521-1 for the first branch 520-1 will be determined as 33, which is the input data size of the HEIGHT axis of the first convolution computation 522. This procedure may be performed by the deep-learning model architecture modification logic that repeats the process of determining the input size of each layer using the output size, parameters and branch type of each layer while performing the layer circulation from the final layer to the first layer of each of the plurality of branches, until the input size of the first layer is determined.

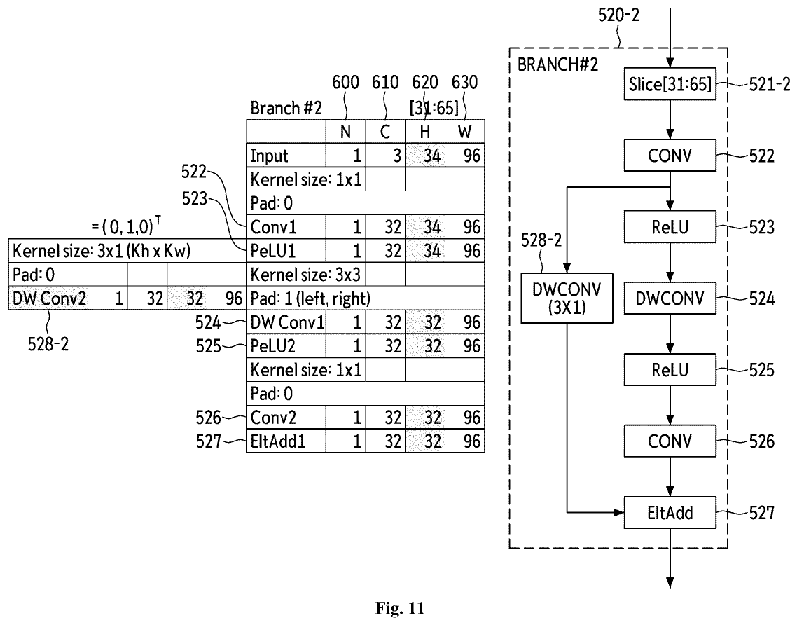

Referring to FIG. 11, in the second branch 520-2 that performs padding of the convolution computation only in two directions (LEFT and RIGHT), the data size of the HEIGHT axis decreases by (padding size+1) each time the convolution computation is performed. If padding is not performed, the data size of the HEIGHT axis does not decrease when performing the convolution computation. As a result, when the second convolution computation 526 with a padding size of 0 is performed, the data size of the HEIGHT axis will be maintained as 32, when the first convolution computation 524 with a padding size of 1 is performed, the data size of the HEIGHT axis will decrease from 34 to 32, and when the first convolution computation 522 with a padding size of 0 is performed, the data size of the HEIGHT axis will be maintained as 34. Since the first convolution operation 522 is the first layer of the second branch 520-2, the data size of the HEIGHT axis of the slice input 521-2 to the slice input 521-2 will be determined to be 34, which is the input data size of the HEIGHT axis of the first convolution computation 522.

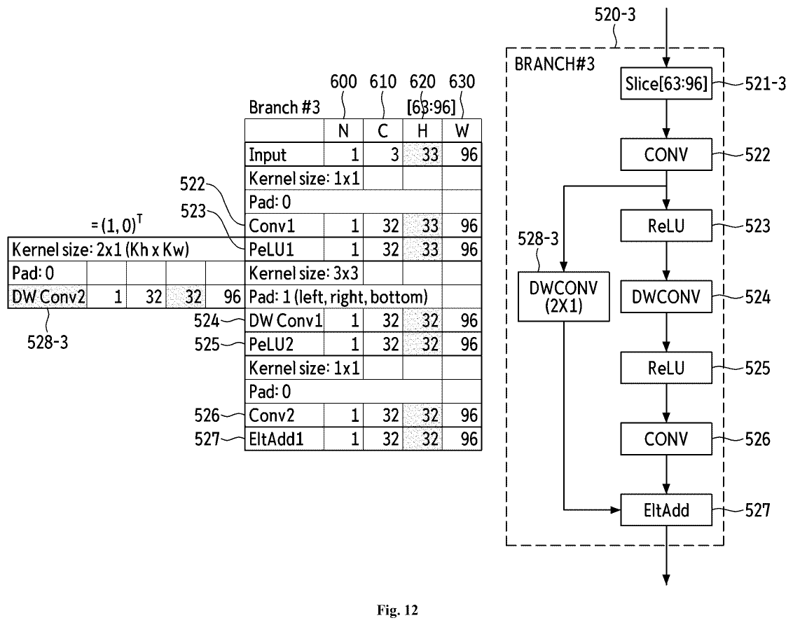

Referring to FIG. 12, in the third branch 520-3 which performs padding for the convolution computation only in the three directions (LEFT, RIGHT, and BOTTOM), the data size of the HEIGHT axis decreases by the padding size each time a convolution computation is performed. If padding is not performed, the data size of the HEIGHT axis does not decrease when performing the convolution computation. As a result, when the second convolution computation 526 with a padding size of 0 is performed, the data size of the HEIGHT axis will be maintained as 32, when the first convolution computation 524 with a padding size of 1 is performed, the data size of the HEIGHT axis will decrease from 33 to 32, and when the first convolution computation 522 with a padding size of 0 is performed, the data size of the HEIGHT axis will be maintained as 33. Since the first convolution operation 522 is the first layer of the third branch 520-3, the data size of the HEIGHT axis of the slice input 521-3 to the first convolution computation 522 will be determined to be 33, which is the input data size of the HEIGHT axis of the first convolution computation 522.

As described referring to FIGS. 10 to 12, the input data size of the HEIGHT axis for the target module 520 is 96, and the input data sizes of the HEIGHT axis for the first to third branches 520-1, 520-2, and 520-3 are determined to be 33, 34, and 33, respectively. The total input data size of the axes is 100, and exceeds 96 which is the input data size of the HEIGHT axis for the target module 520, by 4. Accordingly, it may be understood that there is an overwrap on the HEIGHT axis phase between the respective slice inputs 521-1, 521-2, and 521-3 for each of the first to third branches 520-1, 520-2, and 520-3.

Although there may be an overwrap between the slice inputs 521-1, 521-2, and 521-3 for each of the first to third branches 520-1, 520-2, and 520-3, the final outputs of each of the first to third branches 520-1, 520-2, and 520-3 do not overwrap on the HEIGHT axis which is the reference of the slices. This is because, after determining the data size on the HEIGHT axis of the final output of each of the first to third branches 520-1, 520-2, and 520-3 so that the overwrap does not occur, the input size of each layer is determined using the output size, parameters, and branch type of each layer, while proceeding with layer circulation from the final layer to the first layer of each of the plurality of branches.

As shown in FIG. 8, a layer 540 that generates the final output of the target module using the outputs of each of the plurality of branches may be added to the modified target module 550. The layer that generates the final output of the modified target module may be a CONCATENATE (CONCAT) computation layer 540 that sequentially concatenates the outputs of each of the plurality of branches.

Meanwhile, as shown in FIG. 7, an example target module 520 may include an EltAdd layer 527 that performs an eltwise computation. In this way, in the case where the target module 520 includes a layer that performs the eltwise computation, and padding in a direction parallel to the reference axis of the input data slice is applied to the convolution computation included in the target module 520, when the module is replaced with the plurality of branches, and each branch receives each of a plurality of slice inputs obtained by slicing the input to the target module on the basis of the reference axis, there is a difference between the reference axis data size of the first input and the reference axis data size of the second input of the layer that performs the eltwise computation.

Referring to FIG. 9, because the HEIGHT axis output size of the first convolution layer 522 that provides the first input of the EltAdd layer 527 is 96, and the HEIGHT axis output size of the third convolution layer 526 that provides the second input is also 96, it may be seen that there is no problem in performing the computation of the EltAdd layer 527 in the target module 520 of the original deep-learning model.

Meanwhile, a procedure for verifying whether there is no problem in the computation of the EltAdd layer 527 included in the first branch 520-1 will be described referring to FIG. 10. Because the HEIGHT axis output size of the convolution layer 522 that provides the first input to the EltAdd layer 527 is 33, and the HEIGHT axis output size of the third convolution layer 526 that provides the second input is 32, a difference of 1 occurs, and due to the nature of eltwise computation that may perform the computation only if the data sizes of each input are the same, there is a situation in which the computation of the EltAdd layer 527 included in the first branch 520-1 may not be performed.

To solve the aforementioned problematic situation, a new layer 528-1 for reducing the HEIGHT axis output size of the first convolution layer 522 that provides the first input from 33 to 32 may be added to the first branch 520-1. The new layer 528-1 may be, for example, a layer that performs a depth-wise convolution (DWCONV) computation. As shown in FIG. 10, a filter size of the second DWCONV layer 528-1 may be 2×1 (HEIGHT×WIDTH). Because the HEIGHT axis output size of the second DWCONV layer 528-1 will decrease from 33 to 32, the EltAdd layer 527 of the first branch 520-1 may normally perform the computation, accordingly.

Next, a procedure for verifying whether there is no problem in the computation of the EltAdd layer 527 included in the second branch 520-2 will be described referring to FIG. 11. Since the HEIGHT axis output size of the first convolution layer 522 that provides the first input to the EltAdd layer 527 is 34, and the HEIGHT axis output size of the third convolution layer 526 that provides the second input is 32, a difference of 2 occurs, and there is a situation in which the computation of the EltAdd layer 527 included in the second branch 520-2 may not be performed. To solve such a problematic situation, a second DWCONV layer 528-2 for reducing the HEIGHT axis output size of the first convolution layer 522 that provides the first input from 34 to 32 may be added to the second branch 520-2. The filter size of the second DWCONV layer 528-2 for reducing the HEIGHT axis output size by 2 may be 3×1 (HEIGHT×WIDTH). Since the HEIGHT axis output size of the second DWCONV layer 528-2 will decrease from 34 to 32, the EltAdd layer 527 of the second branch 520-2 may normally perform the computation, accordingly.

Next, a procedure for verifying whether there is a problem in the computation of the EltAdd layer 527 included in the third branch 520-3 will be described referring to FIG. 12. The HEIGHT axis output size of the first convolution layer 522 that provides the first input to the EltAdd layer 527 is 33, and the HEIGHT axis output size of the third convolution layer 526 that provides the second input is 32. Therefore, a difference by 1 occurs, and there is a situation in which the computation of the EltAdd layer 527 included in the third branch 520-3 may not be performed. To solve such a problematic situation, a second DWCONV layer 528-3 for reducing the HEIGHT axis output size of the first convolution layer 522 that provides the first input from 33 to 32 may be added to the third branch 520-3. The filter size of the second DWCONV layer 528-3 for reducing the HEIGHT axis output size by 1 may be 2×1 (HEIGHT×WIDTH). Since the HEIGHT axis output size of the second DWCONV layer 528-3 will decrease from 33 to 32, the EltAdd layer 527 of the third branch 520-3 may normally perform the computation, accordingly.

As described above, in a case where the target module 520 includes a layer that performs the eltwise computation, and padding in a direction parallel to the reference axis of the input data slice is applied to the convolution computation included in the target module 520, when the target module is replaced with a plurality of branches, and each branch receives a plurality of slice inputs obtained by slicing the input to the target module on the basis of the reference axis, since a difference may occur between the reference axis data size of the first input and the reference axis data size of the second input of the layer that performs the eltwise computation, a new layer (e.g., DWCONV) for removing such a difference may be added to each branch. The filter size of the new layer corresponding to the difference between the reference axis data size of the first input and the reference axis data size of the second input may be automatically set.

Each branch is configured when the target module 520 includes a layer that performs the eltwise computation is organized as follows.

The target module includes an eltwise layer that receives a first input that is the output of the first layer, and a second input that is the output of the second layer that is a subsequent layer of the first layer.

The first input of the layer corresponding to the eltwise layer of the first branch is an output of a third-1 layer that receives an output of a first-1 layer corresponding to the first layer, and the second input of the layer corresponding to the eltwise layer of the first branch is an output of a second-1 layer corresponding to the second layer. For example, the third-1 layer may be DWCONV layer 528-1 when the first branch is 520-1 in FIG. 8.

The first input of the layer corresponding to the eltwise layer of the second branch is an output of a third-2 layer that receives an output of a first-2 layer corresponding to the first layer, and the second input of the layer corresponding to the eltwise layer of the first branch is an output of a second-2 layer corresponding to the second layer. For example, the third-2 layer may be DWCONV layer 528-2 when the second branch is 520-2 in FIG. 8.

The third-1 layer and the third-2 layer are layers that perform a reduction on data size of the first axis. The third-1 layer and the third-2 layer are layers that perform a depth-wise convolution (DWCONV) computation, and the parameter indicating an amount of data size reduction of the third-1 layer is a first filter size of the DWCONV computation, and the parameter indicating an amount of data size reduction of the third-2 layer is a second filter size of the DWCONV computation.

The parameter indicating the amount of data size reduction of the third-1 layer is different from the parameter indicating the amount of data size reduction of the third-2 layer. The size of the first filter is smaller than the size of the second filter.

It will be understood that the operations related to the plurality of branch configuration described above referring to FIGS. 7 to 12 include an operation of determining an execution target among a first transformation of parameter modification and a second transformation of a layer creation of parameter modification of at least some layers among the layers included in the target module, using the input size and output size of each layer included in the target module; and an operation of configuring each of the plurality of branches by performing the modification selected as the execution target among the first modification and the second modification on at least some layers included in the target module.

On the other hand, although the target module 520 includes a convolution layer that performs the convolution computation, if all the convolution layers included in the target module add padding to the input data of the convolution computation, it may be determined not to perform both the first modification and the second modification. This is because, if only the convolution computation of no padding environment is performed, the change in the input/output data size of the slice reference axis of the convolution computation does not vary due to slicing of the input data.

In addition, the target module 520 includes a convolution layer that performs the convolution computation, but if both of the convolution layers included in the target module perform a point-width convolution computation (pwCONV), it may be determined that both the first modification and the second modification are not performed. This is because the pwCONV computation only reduces the channel and does not reduce the data size of the WIDTH x HEIGHT side, and therefore, the change in the input/output data size of the slice reference axis of the convolution computation does not vary due to slicing of the input data.

The operations related to the plurality of branch configuration described referring to FIGS. 7 to 12 so far will be organized referring to the detailed flowchart of FIG. 6.

In step S214, the type of each branch may be determined. The type of the branch is any one of a first type, a second type, and a third type. The first type is a branch type that receives the first slice input, the third type is a branch that receives the last slice input, and the second type may be a remaining branch type except the first and third types.

In step S216, the output size of the final layer of each of the plurality of branches may be determined, using the number of branches N. At this time, the output size of the final layer of each branch may be determined, by dividing the data size on the slice reference axis of the final output of the target module 520 by the number of branches.

Next, while proceeding with layer circulation from the final layer to the first layer of each of the plurality of branches S222 and S224, determination (S220) of the input size of each layer using the output size, parameters and branch type of each layer may be repeated until the input size of the first layer is determined (S222).

Next, an example of a method for determining the number of the plurality of branches will be described referring to FIG. 13.

When the example original deep-learning model 700 shown in FIG. 13 includes a layer to be removed, the number of branches included in the plurality of branches may be determined using the input size to the layer to be removed.

The layer to be removed may be a layer which performs the computation involving an access to the memory outside the neural processing unit (NPU) or the memory outside the ALU unit described referring to 4. By removing the layer to be removed, the memory access may be removed, and the effect of increasing the speed of the inference computation may be obtained by such a removal of memory access. An example layer to be removed may be a layer that performs a TRANSPOSE computation and a layer that performs a RESHAPE computation.

The number of branches may be determined so that the size of one of the axes that constitute the input to the TRANSPOSE computation becomes “1”. The input data of the TRANSPOSE computation layers 710, 720 and 730 shown in FIG. 13 have a size of (1, 1024, 18, and 128) (batch, channel, HEIGHT, and WIDTH), and when the number of branches becomes 1024, 18 or 128, the data size of the slice reference axis of the input data of the TRANSPOSE computation layers 710, 720, and 730 will become 1. This makes it possible to remove the TRANSPOSE computation layers 710, 720, and 730. In the example shown in FIG. 13, the number of branches may be any one of 1024, 18, and 128, and when a preset policy adopts the smallest number of selectable branches by priority, the number of branches may be determined to be 18.

Also, when the number of branches is determined so that the RESHAPE computation is removed, the size of the axis that has a size different from the size of the input to the RESHAPE computation among the axes that constitute the output to the RESHAPE computation may be determined to be the number of branches.

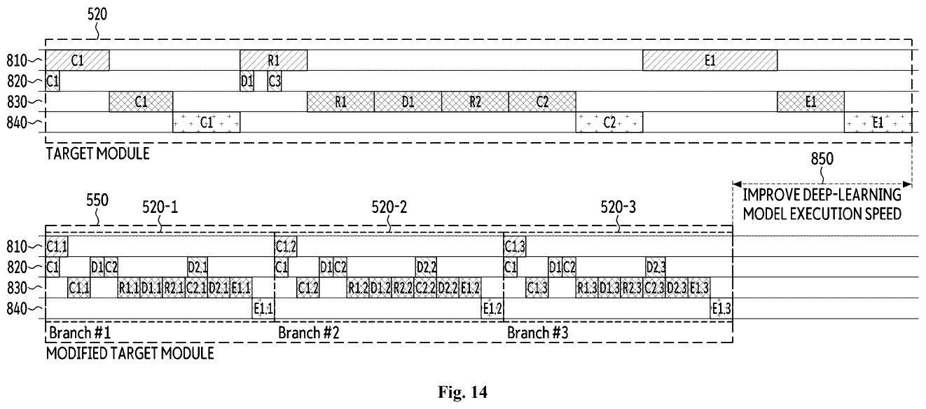

Next, a description will be given referring to FIG. 14.

In FIG. 14, when the NPU performs an inference computation on the target module 520 included in the original deep-learning model using the original deep-learning model shown in FIG. 7 as it is to, an operational sequence (810) for performing a D2S (DRAM TO SRAM) transfer to the feature map, an operational sequence (820) for performing the D2S transfer to weight, an operational sequence (830) for the ALU to perform CONV computation, ReLU computation, and EltAdd computation, and an operational sequence (840) for performing S2D (SRAM to DRAM) transfer to the feature map are shown.

FIG. 14 also shows operational sequences when the NPU sequentially performs the first branch 520-1, the second branch 520-2, and the third branch 520-3 included in the modified target module 550.

As shown in FIG. 14, it may be seen that there is an improvement (850) in the deep-learning model execution speed, as each of the plurality of branches included in the deep-learning model of the modified architecture is sequentially processed. The reason for such an improvement in execution speed may be understood as the fact that by modifying the target module to the plurality of branch architectures, optimization is performed, such as a decrease in the preparation time for each layer process such as D2S transfer to the first RELU computation 523, and an omission of S2D transfer to the first CONV computation (522).

In this way, when the method for modifying the architecture of the deep-learning model according to the present disclosure is applied, a file representing the deep-learning model of the modified architecture is generated, the file is transmitted to the user device, the file is provided to the NPU installed in the user device or an external device, and the NPU may load the provided file and may sequentially process each of the plurality of branches included in the deep-learning model of the modified architecture.

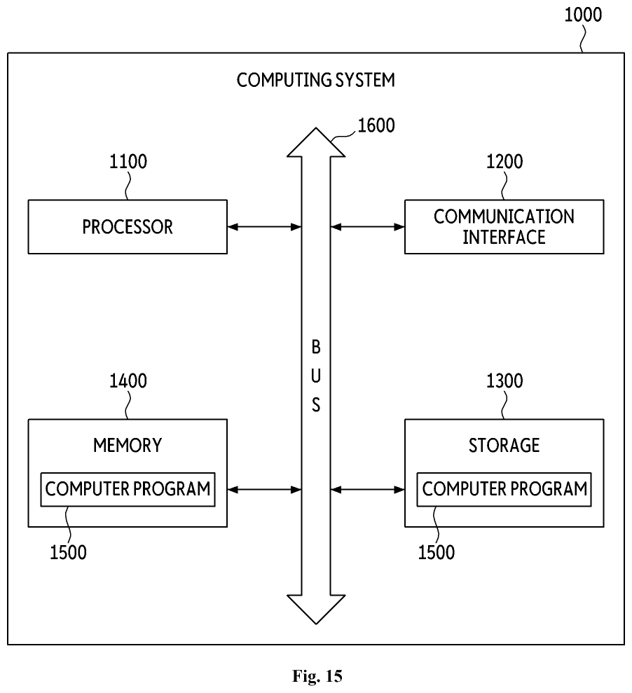

Next, the configuration of an example of the computing system will be described referring to FIG. 15. The computing system 1000 of FIG. 15 may refer to, for example, the AI application developer terminal 300 or the AI application SDK service server 100 described referring to FIG. 1. The computing system 1000 may include one or more processors 1100, a system bus 1600, a communication interface 1200, a memory 1400 for loading a computer program 1500 executed by the processor 1100, and a storage 1300 for storing the computer program 1500. The computing system 1000 may be provisioned through a cloud service, and in this case, the one or more processors 1100, the communication interface 1200, the memory 1400, and the storage 1300 may be all virtualized resources.

Furthermore, the storage 1300 may include parameter data 1550 that defines a binary neural network model learned by the computer program 1500. When the computer program 1500 is loaded into the memory 1400 and executed, the parameter data 1550 may also be loaded into the memory 1400 together. The memory 1400 may be configured to include one or more DRAM modules.

The processor 1100 controls the overall operation of each component of the computing system 1000. The processor 1100 may perform computation on at least one application or program for executing the method/operation. If the computing system 1000 is a device in which the on-device AI described above is deployed, the processor 1100 may be configured using at least a part of one or more NPUs, one or more GPUs, and one or more TPUs. The memory 1400 stores various types of data, instructions, and/or information. The memory 1400 may load one or more computer programs 1500 from the storage 1300 to perform the method/operations. The system bus 1700 provides a communication function between the components of the computing system 1000. The communication interface 1200 supports Internet communication of the computing system 1000. The storage 1300 may non-transitorily store one or more computer programs 1500. The computer program 1500 may include one or more instructions in which the method/operations are implemented. When the computer program 1500 is loaded into the memory 1400, the processor 1100 may execute the one or more instructions to perform the method/operations.

The computer program 1500 may include instructions for determining a target module (which includes a plurality of layers having dependency) among a plurality of layers included in the original deep-learning model, instructions for configuring a plurality of branches (which are independent of each other) using the target module, and instructions for modifying the architecture of the original deep-learning model by replacing the target module with the plurality of branches. The instructions for modifying the architecture of the original deep-learning model may include instructions for configuring so that each of the plurality of slice inputs obtained by slicing the input to the target module on the basis of the first axis is input to each of the plurality of branches.

Various example implementations of the disclosure and effects according to the example implementations have been described with reference to FIGS. 1 to 15. The effects according to the technical idea of the disclosure are not limited to the effects mentioned above, and other effects not described may be clearly understood by those skilled in the art from the description above.

The technical ideas of the disclosure described so far may be implemented as computer-readable code on a computer-readable medium. The computer program recorded on the computer-readable recording medium may be transmitted to another computing device through a network such as the Internet, installed on the other computing device, and thus used on the other computing device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although operations are shown in a specific order in the drawings, it should not be understood that desired results may be obtained when the operations must be performed in the specific order or sequential order or when all of the operations must be performed. In certain situations, multitasking and parallel processing may be advantageous. Although implementations of the disclosure have been described above with reference to the attached drawings, those skilled in the art will understand that the disclosure may be implemented in other specific forms without changing the technical idea or essential features. The example implementations described above should be understood in all respects as illustrative and not restrictive. The scope of protection of the disclosure should be interpreted in accordance with the claims below, and all technical ideas within the equivalent scope should be construed as being included in the scope of rights of the technical ideas defined by this disclosure.

What is claimed is:

1. A method for modifying an architecture of a deep-learning model, the method comprising:
determining a target module among a first plurality of layers included in an original deep-learning model, the target module including a second plurality of layers having dependency;
configuring a plurality of branches based on the target module, the plurality of branches being independent of each other; and
replacing the target module with the plurality of branches, thereby modifying the architecture of the original deep-learning model,
wherein modifying the architecture of the original deep-learning model includes:
obtaining a plurality of slice inputs by slicing an input to the target module with respect to a first axis, and
providing each slice input of the plurality of slice inputs to each branch of the plurality of branches, and
wherein the dependency refers to an output of a previous layer being used as an input of a subsequent layer.

2. The method of claim 1, wherein configuring the plurality of branches includes:
determining, based on an input size and an output size of each layer of the second plurality of layers included in the target module, an execution target among a first modification of a parameter modification and a second modification of a layer creation, the layer creation being of at least some layers among the second plurality of layers included in the target module; and
performing a modification on the at least some layers included in the target module, thereby configuring each branch of the plurality of branches, the modification being selected as the execution target among the first modification and the second modification.

3. The method of claim 2, wherein the target module includes a convolution layer that executes a convolution computation, and
wherein configuring each branch of the plurality of branches includes
configuring a first branch and a second branch, wherein the first branch receives a first slice input among the plurality of slice inputs, and the second branch receives a second slice input immediately after the first slice input, a first plurality of parameters of a layer corresponding to the convolution layer of the first branch being different from a second plurality of parameters of a layer corresponding to the convolution layer of the second branch, and
wherein the first slice input corresponds to a coordinate region including 0 along the first axis.

4. The method of claim 3, wherein configuring the first branch and the second branch includes
setting the first plurality of parameters of the layer corresponding to the convolution layer of the first branch and the second plurality of parameters of the layer corresponding to the convolution layer of the second branch to be different from each other, when padding in at least one direction is added to the input data to the convolution layer.

5. The method of claim 3, wherein configuring the first branch and the second branch includes
configuring the first branch and the second branch to thereby enable a first padding application direction parameter of the convolution layer included in the first branch being different from a second padding application direction parameter of the convolution layer included in the second branch.

6. The method of claim 3, wherein the target module includes an eltwise layer that receives a first input and a second input, the first input being an output of a first layer, and the second input being an output of a second layer that is a subsequent layer of the first layer,
wherein the first input of a layer corresponding to the eltwise layer of the first branch is an output of a third-1 layer that receives an output of a first-1 layer corresponding to the first layer, and the second input of the layer corresponding to the eltwise layer of the first branch is an output of a second-1 layer corresponding to the second layer,
wherein the first input of a layer corresponding to the eltwise layer of the second branch is an output of a third-2 layer that receives an output of a first-2 layer corresponding to the first layer, and the second input of the layer corresponding to the eltwise layer of the first branch is an output of a second-2 layer corresponding to the second layer,
wherein the third-1 layer and the third-2 layer are two layers that reduce data size of the first axis, and
wherein a first parameter indicating an amount of data size reduction of the third-1 layer is different from a second parameter indicating an amount of data size reduction of the third-2 layer.

7. The method of claim 6,
wherein the third-1 layer and the third-2 layer are two layers that perform a depth-wise convolution (DWCONV) computation,
wherein the first parameter indicating the amount of data size reduction of the third-1 layer is a first filter size of the DWCONV computation,
wherein the second parameter indicating the amount of data size reduction of the third-2 layer is a second filter size of the DWCONV computation, and
wherein the first filter size is smaller than the second filter size.

8. The method of claim 2,
wherein the target module includes a convolution layer that performs a convolution computation, and
wherein the method includes determining, based on padding being not added to input data of the convolution computation, that the convolution layer included in the target module does not perform both the first modification and the second modification.

9. The method of claim 2,
wherein the target module includes a convolution layer that performs a convolution computation, and
wherein the method includes determining, based on performing a point-wide convolution computation (pwCONV), that the convolution layer included in the target module does not perform both the first modification and the second modification.

10. The method of claim 1, wherein modifying the architecture of the original deep-learning model includes adding, based on a plurality of outputs of the plurality of branches, a layer that generates a final output of the target module.

11. The method of claim 10,
wherein the plurality of slice inputs partially overlap a plurality of adjacent slice inputs, and
wherein the layer that generates the final output concatenates the plurality of outputs of the plurality of branches.

12. The method of claim 1, wherein obtaining the plurality of slice inputs includes:
identifying a plurality of types of the plurality of branches as one of a first type, a second type, or a third type, the first type being a branch type that receives a first slice input, the third type being a branch type that receives a last slice input, and the second type being a remaining branch type except the first type and the third type;
determining an output size of a final layer of each branch of the plurality of branches; and
repeating determination of an input size of each layer of the second plurality of layers based on an output size, a plurality of parameters, and a branch type of the respective layer, until the input size of a first layer is determined.

13. The method of claim 1, wherein configuring the plurality of branches includes:
determining that the target module includes a layer to be removed; and
determining, based on an input size to the layer to be removed, a number of branches included in the plurality of branches.

14. The method of claim 13, wherein the layer to be removed performs a computation involving an access to a memory outside a neural processing unit (NPU).

15. The method of claim 14, wherein the layer to be removed includes at least one of a layer that performs a TRANSPOSE computation and a layer that performs a RESHAPE computation.

16. The method of claim 15, wherein determining the number of branches included in the plurality of branches includes
determining the number of branches to thereby enable a size of an axis that constitutes an input to the TRANSPOSE computation to be 1.

17. The method of claim 15, wherein determining the number of branches included in the plurality of branches includes
determining, based on the number of branches, a size of an axis that constitutes an output to the RESHAPE computation, the size of the axis being different from a size of an input to the RESHAPE computation.

18. The method of claim 1, wherein modifying the architecture of the original deep-learning model includes:
generating a file that represents the deep-learning model of the modified architecture; and
transmitting the file to a user device,
wherein the file is provided to an NPU installed in the user device or an external device, and
wherein the NPU loads the provided file, and sequentially processes each branch of the plurality of branches included in the deep-learning model of the modified architecture.

19. A method performed by a system-on-chip (SoC), the method comprising:
receiving an input of data representing an original deep-learning model;
determining a target module among a first plurality of layers included in the original deep-learning model, the target module including a second plurality of layers having dependency;
configuring a plurality of branches based on the target module, the plurality of branches being independent of each other;
replacing the target module with the plurality of branches, thereby modifying an architecture of the original deep-learning model; and
sequentially processing each branch of the plurality of branches included in the deep-learning model of the modified architecture,
wherein modifying the architecture of the original deep-learning model includes
obtaining a plurality of slice inputs by slicing an input to the target module with respect to a first axis, and
providing each slice input of the plurality of slice inputs to each branch of the plurality of branches, and
wherein the dependency refers to an output of a previous layer being used as an input of a subsequent layer.

20. A neural processing unit (NPU) comprising:
a controller including a control logic and a cache; and
a plurality of arithmetic logic unit (ALU) circuits including an ALU and a cache,
wherein the control logic includes a model optimization logic,
wherein the model optimization logic is configured to:
determine a target module among a first plurality of layers included in an original deep-learning model, the target module including a second plurality of layers having dependency,
configure a plurality of branches based on the target module, the plurality of branches being independent of each other,
replace the target module with the plurality of branches, thereby modify an architecture of the original deep-learning model, and
control each branch of the plurality of branches included in the deep-learning model of the modified architecture to be processed sequentially,
wherein modifying the architecture of the original deep-learning model includes
obtaining a plurality of slice inputs by slicing an input to the target module with respect to a first axis, and
providing each slice input of a plurality of slice inputs to each branch of the plurality of branches and
wherein the dependency refers to an output of a previous layer being used as an input of a subsequent layer.
